(19) United States
(12) Patent Application Publication
(10) Pub. No.: US 2005/0108097 A1
(43) Pub. Date: May 19, 2005

(54) Web-based food ordering system utilizing a text-to-speech engine

(75) Inventor: G. Christopher McAleenan, Grand Rapids, MI (US)

Correspondence Address: PRICE HENEVELD COOPER DEWITT & LITTON, LLP, 695 KENMOOR, S.E., P O BOX 2567, GRAND RAPIDS, MI, 49501, US

(73) Assignee: Simpledine, Inc.

(21) Appl. No.: 10/993,051

(22) Filed: Nov. 19, 2004

Related U.S. Application Data
(60) Provisional application No. 60/523,381, filed on Nov. 19, 2003.

(51) Int. Cl. G06F 17/60

(52) U.S. Cl. 705/15

(57) ABSTRACT

A web-based food ordering system includes a customer computer system in communication with a server. The server hosts a restaurant related web site that provides web pages of restaurant information for participating restaurants to a customer, via the customer computer system. The server is coupled to a public telephone network and the server provides verbal order information to a selected one of the participating restaurants responsive to input from the customer provided via the customer computer system. The input from the customer includes a special order entry in textual format.

This application claims the benefit of U.S. Provisional Patent Application Ser. No. 60/523,381 entitled, “WEB-BASED FOOD ORDERING SYSTEM UTILIZING A TEXT-TO-SPEECH ENGINE,” by Christopher G. McAleenan et al., filed Nov. 19, 2003, the entire disclosure of which is hereby incorporated by reference herein.

### BACKGROUND OF THE INVENTION

The present invention generally relates to a web-based food ordering system, and more particularly relates to a web-based food ordering system that allows customers to order food from various restaurants over a common web portal.

Prior web-based food ordering systems have been commercialized without a great deal of success. A problem with most of the prior systems is that they require a change in operating procedure on the part of the participating restaurants. In addition, the web sites tend to be overcrowded, complicated and generally non-user friendly. On-line ordering is usually cumbersome and may require human intervention on the part of the company operating the web site to either fax or call in the order to the restaurant. In addition, most of the companies operating these web sites seek to simply insert themselves as a middle man into the order process.

Accordingly, there exists a need for a web-based food ordering system that allows restaurants to participate without changing their normal operating procedure.

### SUMMARY OF THE INVENTION

The present invention is generally directed to a web-based food ordering system that includes a customer computer system that is in communication with a server. The server hosts a restaurant related web site that provides web pages of restaurant information for participating restaurants to a customer, via the customer computer system. The server is coupled to a public telephone network and the server provides verbal order information to a selected one of the participating restaurants responsive to input from the customer, provided via the customer computer system. The input from the customer includes a special order entry in textual format.

According to another aspect of the present invention, the restaurant information includes at least one of a restaurant menu, a coupon and a current promotion. According to another embodiment of the present invention, the web site includes a public area for access by a potential customer, a restaurant administrative area for access by participating restaurants and a system administration area for access by a system administrator. The public area is accessible to all web site users and provides access to the restaurant information. According to a different aspect of the present invention, the input from the customer includes payment information, such as credit card account information.

According to another aspect of the present invention, the server initiates a telephone call to a selected one of the participating restaurants, via a public telephone network, to provide the verbal order information to the selected one of the participating restaurants. According to another embodiment, the server provides a phone number of the customer to the selected one of the participating restaurants. According to a different aspect, the server automatically initiates a telephone call between the selected one of the participating restaurants and the customer. According to one embodiment of the present invention, the server and the customer computer system communicate via the Internet.

According to yet another embodiment of the present invention, the server stores an order history for the customer that includes at least one past order. According to this aspect of the invention, the order history for the customer can be made available to the customer for a current order. Thus, in this manner, the customer is not required to re-enter the information from the at least one past order to place a current order that is the same as the past order.

These and other features, advantages and objects of the present invention will be further understood and appreciated by those skilled in the art by reference to the following specification, claims and appended drawings.

### BRIEF DESCRIPTION OF THE DRAWINGS

FIG. 1 is a schematic representation of a preferred implementation of the present invention;

FIG. 1A is a block diagram of an exemplary computer system; and

FIG. 2 is a flow chart of an exemplary routine for implementing a web-based food ordering system that utilizes a text-to-speech engine.

### DETAILED DESCRIPTION OF THE INVENTION

The present invention provides an end-to-end solution that leverages technology to bring customers and restaurants closer together. The present invention allows the customers to place food orders on-line over the Internet. Through the unique utilization of a text-to-speech engine to translate orders placed on-line into standard telephone orders, restaurants are empowered to accept on-line orders without changing their current operating procedures. The present invention also utilizes unique data gathering and presentation techniques that allow restaurants to target customers in a precise manner, thus reducing the inefficiencies found in current marketing practices.

As will become apparent from the following discussion, the present invention is initially targeted towards college students. Nevertheless, those skilled in the art will appreciate that the invention may be targeted towards any other potential customers. The initial target market is selected due to the fact that the Internet has become a significant means of communication for college students, rivaling that of the telephone.

In college markets, restaurants often rely upon blind marketing (i.e., campus-wide flyer campaigns) to target college students. The most common advertising techniques target either the entire school population or only current customers. A student's choice in restaurant is often limited to the paper menus that he or she has collected. This information is not searchable in any meaningful way and creates a barrier to other restaurants seeking those students' business. The present invention eliminates many of these market inefficiencies, as will be described further below.

The present invention also provides restaurants with a new and extremely powerful vehicle to reach customers. Specifically, restaurants benefit from the following key features of the present invention: on-line order acceptance, targeted marketing and on-line coupons. On-line order acceptance enables restaurants using the present invention to accept orders from on-line users rather than only traditional telephone and fax orders. The present invention provides targeted marketing by providing complete electronic access to ordering and purchase history as well as category trends that allow restaurants to make informed marketing decisions. In addition, the present invention provides the capability to release promotional offers on-line, which cut printing costs dramatically. Combined with the marketing data provided by the present invention, restaurants can potentially benefit from a much higher return on coupon offerings.

As will also be explained further below, the present invention provides several benefits to the consumer that will continue to draw the consumer to the web site. These benefits may include: restaurant search, on-line ordering, custom coupons and favorite/past orders. The restaurant search feature allows customers to sort restaurants by a variety of criteria, such as cuisine type, coupon availability, price, hours of operation and delivery area. On-line ordering enables customers to view a complete on-line menu of a restaurant, when the menu is selected. The customers may place an order without worrying about voice ambiguities, being placed on hold, menu confusion and the host of other problems inherent to telephone orders. Once an order has been confirmed by the restaurant, the customer may be notified via the Internet and an approximate delivery time is given. Future orders may also be stored and accepted.

Another benefit offered to the customer is the provision of custom coupons. Coupons are often misplaced, forgotten, or simply not useful to the consumer. Because the present invention allows restaurants to target customers based on taste and past purchases, coupons obtained through the present invention are typically relevant. In addition, coupons are fully searchable so a customer can choose the restaurant that can offer him/her the best deal. By storing all past and favorite orders, the system of the present invention allows customers to reorder preferred meals with one click. This eliminates the need to repeat orders over the phone and saves valuable time.

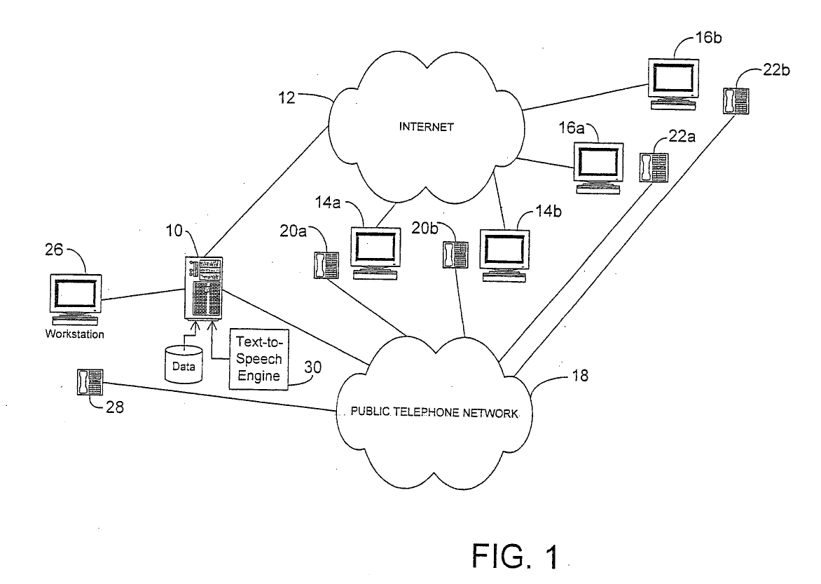

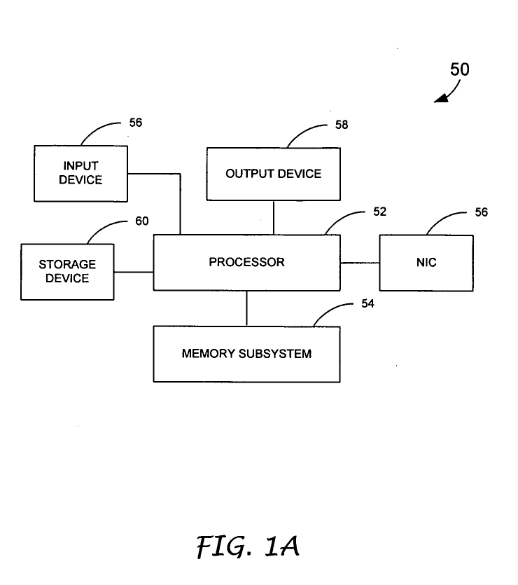

FIG. 1 is a schematic illustration of the system as it may be employed in a preferred implementation. As illustrated, the system employs one or more servers 10 connected to the Internet 12. Also connected to the Internet are a plurality of computers (shown as computers 14a and 14b), which may each be associated with a participating restaurant. A plurality of computers is also connected to the Internet (represented as 16a and 16b) each representing the computers of the customers or potential customers. The system may further include one or more computer terminals 26 provided in the web site administrator's offices, which are connected either directly to server 10 or via the Internet 12.

As described further below, one or more servers 10 are preferably connected to the public telephone network 18, which in turn is connected to a plurality of telephones (shown as telephones 20a and 20b), each associated with participating restaurant. Clearly, any restaurant which presently takes telephone orders would at least have such a telephone. As explained further below, it is not necessary for each participating restaurant to have a computer 14a, 14b. However, the provision of a computer connected to the Internet provides certain functional benefits for the restaurants. Using the inventive system, restaurant owners/managers can access the system from anywhere, including via connected PDAs/cellular telephones for changes on the fly.

Also connected to the public telephone network is a plurality of telephones (represented as telephones 22a and 22b), which are owned or maintained for one or more of the customers or potential customers. As will be apparent from the following discussion, it may not be necessary that the customer or potential customer have such a telephone. Telephone 28, which is also connected to public telephone network 18, may be provided at the administrator's office for the web site, either at the same location as server 10 or at a remote location.

With reference to FIG. 1A, a block diagram of an exemplary computer system 50 is depicted. It should be appreciated that the server 10, restaurant computer systems 14a and 14b and customer computer systems 16a and 16b have the general form of the computer system 50. As is shown, a processor 52 is coupled to a memory subsystem 54, which includes an application appropriate amount of volatile memory, e.g., random access memory (RAM), and non-volatile memory, e.g., read-only memory (ROM). The processor 52 is also coupled to a storage device 60, which may take various forms, such as a hard disc drive, CD ROM, etc. The processor 52 is also coupled to an input device 56, which may include various input devices, such as a mouse and/or a keyboard. The processor 52 displays various information to a user of the system 50, via an output device 58, which may be, for example, a liquid crystal display (LCD) or a cathode ray tube (CRT), among other such display devices. The processor 52 is also coupled to a network interface card (NIC), which includes circuitry for communicating with another computer system over a communication link, e.g., the Internet, and/or may include circuitry for providing synthesized speech over a public telephone network.

The server(s) 10 may include a web application server, a database server and a text-to-speech (TTS) server. Additional servers may be added to meet demand. These servers may use various operating systems, however, it is preferred that the servers run either the Linux or FreeBSD operating system. The system application pages may be served by any conventional web server, but are preferably served by an Apache web server. The database server platform may likewise be any conventional database server application, however, it is preferred that the database server platform is MySQL. The web site development language may be any conventional language, however, it is preferred that PHP development language is used as the development platform.

Server(s) 10 is configured to host a web site having the functions and features described below. The web site may be constructed using any conventional software and using conventional design techniques. The web site preferably includes three primary components. The first component is the public web site, which allows visitors to access restaurant information, on-line menus, coupons and promotions and the e-commerce system for placing orders. The web site also includes a restaurant administrative area, which allows restaurant personnel to update their information, which may include menus, coupons, advertisements, locations, etc. The third area is a system administration area that allows the web site operator to create and maintain student and restaurant accounts, as well as monitor web site activity. The primary preferred features and functionality for each of these three areas are described below.

In the public area of the web site, visitors have the ability to perform a variety of activities, including: browsing restaurants in their area; reviewing on-line menus and coupons offered by each restaurant; searching for specific restaurants by name, menu items, category (e.g., Italian, Chinese, pizza, etc.), coupons, takeout, or delivery; and placing orders on-line by selecting items from a restaurant's menu and entering their delivery and payment information, setting up and logging into their personal account, contacting the web site administrator with questions and feedback about the site and signing up to receive e-mail notifications about new restaurants, special offers and coupons.

In a preferred web site construction, the visitor would go through the process of selecting items from a restaurant's on-line menu with functionality similar to a traditional e-commerce site. For example, this may involve adding products to an on-line shopping cart and then proceeding to checkout. Credit card numbers may be accepted during a secured checkout process, although restaurants may choose to accept payment on delivery/pickup.

As described further below, when a visitor places an order, the server connects with a text-to-speech application 30, which is running on server 10. The text-to-speech application instigates an automated telephone call to the restaurant via public telephone network 18 and the appropriate telephone 20a or 20b corresponding to the participating restaurant. The restaurant may then accept or deny the order, sending the information back through the text-to-speech system to the web site. Using a separate application and process, the server 10 can also send orders to a restaurant via fax. Accordingly, the system of the present invention will translate a restaurant's current process of taking orders over the telephone to an on-line environment. From a customer's point of view, the customer will have a convenient way to review restaurants in their area, take advantage of coupons and place orders on-line.

Although any preferred text-to-speech engine may be used for application 30, the text-to-speech engines produced by Voxeo are the preferred applications. One advantage of using a text-to-speech engine is that special order entries may be entered by the customer into an appropriate text field on the web site and then converted to speech (verbal order information) and transmitted over the telephone to the participating restaurant.

The text-to-speech application may also be programmed and configured to pass along the caller identification of the customer rather than that of the web site administrator when calling the restaurant to place an order. The system may also prompt the restaurant to press a key (e.g., the “#” key) to automatically connect to the customer's telephone number.

During the order and checkout process, the visitor may be required to create an account on the system containing their name, school, address, login/password and payment information. The user account may include a feature that will, upon login, give the user access to a number of features, including: a listing of pending orders (including items ordered, total charge, expected delivery/pickup time); complete order history with the ability to reorder as desired; and general account information including the above-noted information that is used to create the account. By transmitting a “cookie” to the user's computer, this information may be automatically brought up when the user accesses the web site.

The restaurant administrative area of the web site allows participating restaurants to login to the web site to create and administer their accounts and to access a number of on-line tools including: their “dashboard” showing the number of orders placed, total sales, average price per order and the top-selling items for a given week; management of items, options and pricing offered on their on-line menu; management of their account information and preferences (style sheet, name, hours of operation, location served, minimum delivery amount, delivery fees, telephone/fax number, address, etc.); review of their order history and running sales reports by date range; and management of their on-line coupons and bidding.

The on-line menus may be organized by categories (e.g., appetizers, salads, beverages, entrees, etc.) with individual items contained in each category. Using the menu management tool, restaurant personnel can create new categories, enter the name and description, upload an image and define sizes for the category. Once categories have been created, the restaurant personnel can add menu items, enter the name and description, upload an image, select its category, enter pricing (based on sizes for that category), select delivery availability (delivery, pickup, or both) and enter options for the item (toppings, dressings, sauces, etc.).

Options can be created for individual menu items (if applicable). Options are a group of additions to a menu item. Using the menu management tool, the restaurant personnel may create a new option by entering the name of the option group (such as pizza toppings or salad dressing) and defining the group type. Option types may be exclusive (a single choice from the group, chosen by the customer using a radio button interface, non-exclusive, multiple choices from the group selected using checked boxes), or quantity (open field entered by the customer). The restaurant personnel then add individual options and define which type they are and can assign a price to each. Because of the unique manner in which pizza toppings are applied (either to a whole pizza or in combination by halves), they will be considered a special/separate option group by the system.

The hierarchy of data for the on-line menu is:

Category
Name
Description
Image (optional)
Sizes (if applicable)
Menu Items
   Name
   Description
   Image (optional)
   Category
   Price (by size, if applicable)
   Delivery availability
   Options (if applicable)
   Options
      Name
      Type
      Items
      Price per item (if applicable)
         In addition to setting up their menus as described above, participating restaurants will also have the ability to create on-line coupons. Using the coupon management tool, restaurant personnel may create coupons, assign a special price and schedule the coupons for display on the site. Essentially, the system treats coupons as individual product listings with a special price and description. When creating a new coupon, the restaurant personnel will click the “add a coupon” button/link in the restaurant administration area, bringing up an entry form similar to the form for adding a new menu item. Using the coupon entry form, the restaurant personnel will perform the following steps: enter the name and description (e.g., “Two Pie Special” and “Buy one cheese pizza and get the second one free!”), upload a photograph/image, enter the price, select delivery options (pickup, delivery, or both), select the options, define the minimum order amount and enter a date range for displaying the coupon. The category field will be pre-filled/locked as “coupon” because coupons are in their own category. Using the system of the present invention, participating restaurants can create two different forms of coupons: minimum order discounts and product-specific discounts. The versatility of this approach allows restaurants to create a number of different coupons such as “Buy one, get one free,” “Two pizzas for $10,” “Free breadsticks with every order,” etc.

In addition to displaying their coupons on their restaurant's main page, participating restaurants can also bid on placing their coupons on the restaurant finder results page. On a daily basis, restaurants can set a bid for the amount they are willing to pay per day to have their coupon appear on the results page. Bids are applied to individual coupons, so the restaurant will have the ability to place separate bids for their coupons. The system will display the top five bid coupons for that day on the results page, sorted by the bid amount (highest at the top). The system of the present invention may automate this process to eliminate the need for manual administrative bid selection.

The present invention will also allow restaurants to have the ability to bid for top placement (or “sponsored links”) in the find a restaurant and search results pages. Like coupons, bids for restaurant listings can be placed/updated on a daily basis. The three highest bids or listings for a given day will appear at the top of the search results separate from the other restaurant listings.

In the system administrative area, the web site includes a password protection scheme such that only administrative personnel are able to perform certain designated administrative tasks. Such administrative tasks include: creating new restaurant accounts, including uploading photos/logos and setting style sheets to fit the restaurant's brand identity; maintaining restaurant accounts, including category placement, menus and coupons to provide restaurants with access to all the restaurant administrative tools and capabilities listed above; creating and maintaining customer accounts; and exporting restaurant account data (bidding charges and sales commissions) in a standard delimited format for importing into the system administrator's accounting software.

The web site is also preferably configured to allow the web site administrative personnel to review comprehensive site activity and performance reports by date range, including: site visitors/traffic; total sales/orders; sales/orders by restaurant; average sale per order; commissions by restaurant; restaurant visitors/traffic; sales/orders by category; coupon sales; total commissions; and commissions by category.

As discussed above, the system may also be used to fax orders from the server to the restaurant. This may be done over the Internet or via telephone lines in the public telephone network. One technique is to install faxing software directly on web server 10 and connect it to the public telephone network via a set of fax modems. A second method is to use a service which offers e-mail-to-fax gateways via a standard Internet connection.

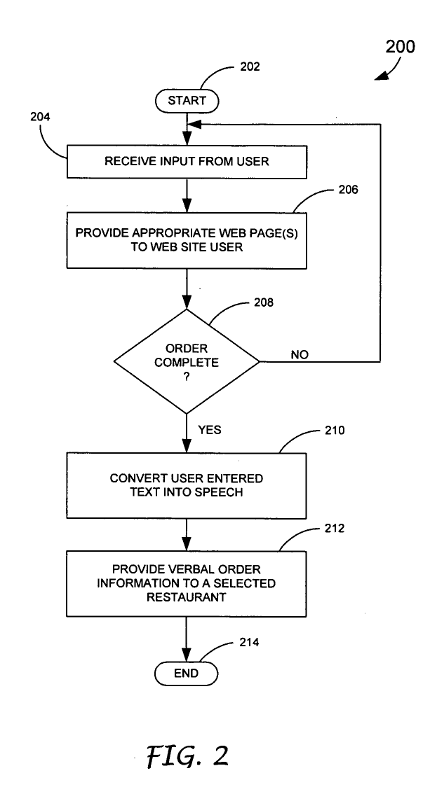

With reference to FIG. 2, an exemplary routine 200 for implementing a web-based food ordering system is disclosed. In step 202, the routine 200, which executes on the server 10, is initiated. Then, in step 204, a user accesses the web site (by entering an appropriate universal resource locator (URL) in the user's web browser) and provides input to the server 10. At least a portion of the input may indicate what type of food the user is interested in, as well as the user's selections from the various restaurant information and a special order entry in textual format. Next, in step 206, the server 10 causes appropriate web pages (based on a user's input) to be provided to the web site user, e.g., one of the computer systems 16a or 16b, which may be utilized by the customer. Next, in decision 208, the server 10 determines whether the order is complete, i.e., whether the user has indicated that they are finished and wish to place their order. If so, control transfers to step 210. Otherwise, control loops to step 204, where the server 10 receives additional input from the web site user. In step 210, the server 10 runs a text-to-speech application and converts user entered selections and special order entry text into speech. Next, in step 212, the server 10 establishes a communication link with a selected restaurant so as to provide verbal order information to the selected restaurant. Upon providing the verbal order information to the selected restaurant and after receiving proper confirmation of the order placement, the routine 200 terminates in step 214.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention.

1. A web-based food ordering system, comprising:
a customer computer system; and
a server in communication with the customer computer system, the server hosting a restaurant related web site that provides web pages of restaurant information for participating restaurants to a customer via the customer computer system, wherein the server is coupled to a public telephone network, and wherein the server provides verbal order information to a selected one of the participating restaurants responsive to input from the customer provided via the customer computer system, where the input from the customer includes a special order entry in textual format.

2. The system of claim 1, wherein the restaurant information includes at least one of a restaurant menu, a coupon and a current promotion.

3. The system of claim 1, wherein the web site includes a public area for access by a potential customer, a restaurant administrative area for access by the participating restaurants and a system administration area for access by a system administrator.

4. The system of claim 3, wherein the public area is accessible to all web site users, and wherein the public area provides access to the restaurant information.

5. The system of claim 1, wherein the input from the customer includes payment information.

6. The system of claim 1, wherein the server initiates a telephone call to the selected one of the participating restaurants via a public telephone network to provide the verbal order information to the selected one of the participating restaurants.

7. The system of claim 6, wherein the server provides a phone number of the customer to the selected one of the participating restaurants.

8. The system of claim 6, wherein the server automatically initiates a telephone call between the selected one of the participating restaurants and the customer.

9. The system of claim 1, wherein the server and the customer computer system communicate via the Internet.

10. The system of claim 1, wherein the server stores an order history for the customer that includes at least one past order.

11. The system of claim 10, wherein the order history for the customer is made available to the customer for a current order, and wherein the customer is not required to re-enter the information from the at least one past order to place a current order that is the same as the past order.

12. A web-based food ordering system, comprising:
a customer computer system; and
a server in communication with the customer computer system, the server hosting a restaurant related web site that provides web pages of restaurant information for participating restaurants to a customer via the customer computer system, wherein the server is coupled to a public telephone network, and wherein the server provides verbal order information to a selected one of the participating restaurants responsive to input from the customer provided via the customer computer system, where the input from the customer includes a special order entry in textual format, and where the server initiates a telephone call to the selected one of the participating restaurants via a public telephone network to provide the verbal order information to the selected one of the participating restaurants.

13. The system of claim 12, wherein the restaurant information includes at least one of a restaurant menu, a coupon and a current promotion.

14. The system of claim 12, wherein the web site includes a public area for access by a potential customer, a restaurant administrative area for access by the participating restaurants and a system administration area for access by a system administrator.

15. The system of claim 12, wherein the input from the customer includes payment information.

16. The system of claim 12, wherein the server provides a phone number of the customer to the selected one of the participating restaurants.

17. The system of claim 16, wherein the server automatically initiates a telephone call between the selected one of the participating restaurants and the customer.

18. A web-based food ordering system, comprising:
a customer computer system; and
a server in communication with the customer computer system, the server hosting a restaurant related web site that provides web pages of restaurant information for participating restaurants to a customer via the customer computer system, wherein the server is coupled to a public telephone network, and wherein the server provides verbal order information to a selected one of the participating restaurants responsive to input from the customer provided via the customer computer system, where the input from the customer includes a special order entry in textual format, and where the server initiates a telephone call to the selected one of the participating restaurants via a public telephone network to provide the verbal order information to the selected one of the participating restaurants and the server and the customer computer system communicate via the Internet.

19. The system of claim 18, wherein the restaurant information includes at least one of a restaurant menu, a coupon and a current promotion.

20. The system of claim 18, wherein the input from the customer includes payment information.

21. The system of claim 18, wherein the server provides a phone number of the customer to the selected one of the participating restaurants.

22. The system of claim 18, wherein the server automatically initiates a telephone call between the selected one of the participating restaurants and the customer.
